(19) United States
(12) Patent Application Publication
(10) Pub. No.: US 2026/0208714 A1
(43) Pub. Date: Jul. 23, 2026

(54) CONTROL SYSTEM

(71) Applicant: Robert Bosch GmbH, Stuttgart (DE)

(72) Inventors: Shunsuke Takayama, Kanagawa (JP); Yusei Kimura, Kanagawa (JP)

(21) Appl. No.: 19/135,888

(22) PCT Filed: Nov. 28, 2023
(86) PCT No.: PCT/IB2023/061961

§ 371 Date: Jun. 5, 2025

(30) Foreign Application Priority Data
Dec. 9, 2022 (JP) 2022-197163

(51) Int. Cl. B60T 13/74; B60T 7/04

(52) U.S. Cl. CPC B60T 13/74; B60T 7/04

(57) ABSTRACT

To improve driver's comfort.

A control system 10 for controlling the operation of a vehicle 1, the control system 10 including: a sensor 11 that detects an operation amount of an operation unit 20 operated by a driver of the vehicle 1 and outputs output information in accordance with the operation amount ; and a control apparatus 12 that can execute a sleep mode in which power consumption of the vehicle 1 is suppressed. The control apparatus 12 can switch and execute a first mode which is executed while the sleep mode is inactive and acquires the operation amount based on the output information, and a second mode which is executed while the sleep mode is active and deactivates the sleep mode based on the output information. A correspondence relationship between the operation amount and the output information in the sensor 11 differs between the first mode and the second mode.

### BACKGROUND

The present invention relates to a control system.

In a vehicle, various types of controls are performed using a sensor that detects an operation amount of a control unit operated by a driver and outputs output information in accordance with the operation amount. For example, JP2020-028155A discloses an electric booster that assists a brake operation force of a driver. The operation of the electric booster is controlled using output information of a sensor that detects an operation amount of a brake operation unit used for a brake operation.

As described above, the sensor that detects the operation amount of the operation unit is basically used by a control apparatus to acquire the operation amount of the operation unit as information. It is considered desirable to improve driver's comfort by using such a sensor for multiple purposes.

### SUMMARY

The invention has been made in view of the above problem, and an object of the invention is to provide a control system that can improve driver's comfort.

In order to solve the above problem, the control system is a control system for controlling the operation of a vehicle, and the control system includes: a sensor that detects an operation amount of an operation unit operated by a driver of the vehicle and outputs output information in accordance with the operation amount; and a control apparatus that can execute a sleep mode in which power consumption of the vehicle is suppressed. The control apparatus can switch and execute a first mode which is executed while the sleep mode is inactive and acquires the operation amount based on the output information, and a second mode which is executed while the sleep mode is active and deactivates the sleep mode based on the output information. A correspondence relationship between the operation amount and the output information in the sensor differs between the first mode and the second mode.

According to the invention, the driver's comfort can be improved.

### BRIEF DESCRIPTION OF DRAWINGS

FIG. 1 is a schematic diagram illustrating a schematic configuration of a vehicle according to an embodiment of the invention.

FIG. 2 is a flowchart illustrating an example of a processing flow performed by a control apparatus according to the embodiment of the invention.

FIG. 3 is a diagram illustrating a correspondence relationship between an operation amount and output information in a sensor in a first mode according to the embodiment of the invention.

FIG. 4 is a diagram illustrating a correspondence relationship between an operation amount and output information in the sensor in a second mode according to the embodiment of the invention.

### DETAILED DESCRIPTION

A preferred embodiment of the invention will be described in detail below with reference to the accompanying drawings. Dimensions, materials, other specific numerical values, and the like shown in the embodiment are only given as examples for facilitating understanding of the invention, and do not limit the invention unless otherwise specified. In the present specification and the drawings, components having substantially the same functions and configurations are denoted by the same reference signs to omit redundant descriptions, and components not directly related to the invention are not illustrated.

### Configuration of Vehicle

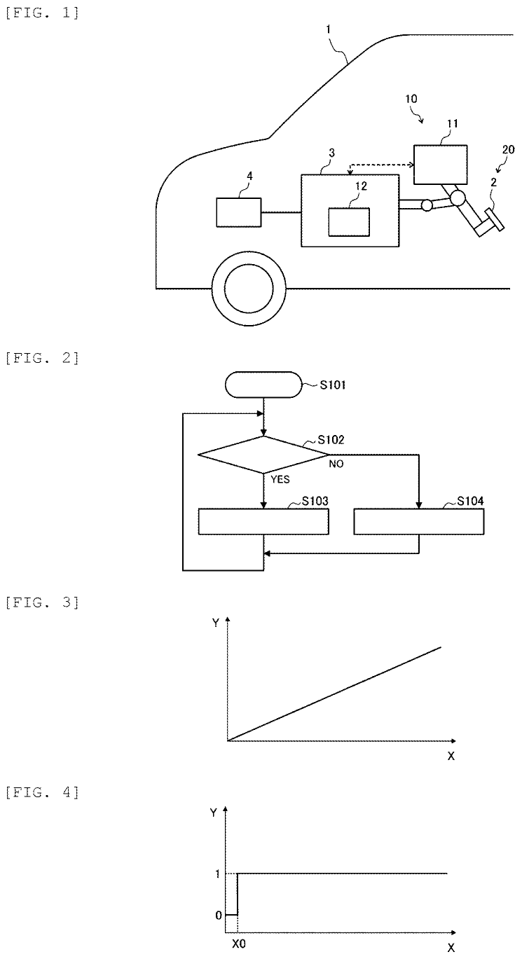

A configuration of a vehicle 1 according to an embodiment of the invention will be described with reference to FIG. 1.

FIG. 1 is a schematic diagram illustrating a schematic configuration of the vehicle 1. As illustrated in FIG. 1, the vehicle 1 includes a brake operation unit 2, an electric booster 3, and a hydraulic pressure control unit 4. The brake operation unit 2 is equivalent to an example of an operation unit 20 operated by a driver of the vehicle 1. In addition, as will be described below, the vehicle according to the invention is not limited to the example in FIG. 1, and may be a vehicle that is not provided with the electric booster 3.

The brake operation unit 2 is used for a brake operation for braking the vehicle 1. The brake operation unit 2 is operated by a foot of the driver. The brake operation is an operation of pushing the brake operation unit 2 by the foot of the driver.

The electric booster 3 assists a brake operation force (that is, a force of pushing the brake operation unit 2) by the driver. Specifically, the electric booster 3 includes an electric motor, and the operation of the electric motor is controlled at the time of the brake operation so as to assist the brake operation force of the driver.

The hydraulic pressure control unit 4 has a function of regulating a brake fluid pressure of a wheel cylinder in a brake caliper attached to each wheel. For example, an oil passage of the hydraulic pressure control unit 4 is provided with a pump and a solenoid valve, and the operations of the pump and the solenoid valve are controlled so as to regulate the brake fluid pressure that gives a braking force to each wheel. The brake fluid pressure generated by a master cylinder in accordance with the brake operation by the driver is supplied to the wheel cylinder via the hydraulic pressure control unit 4.

As illustrated in FIG. 1, the vehicle 1 includes a control system 10 that controls the operation of the vehicle 1 by performing processing using an operation amount of the operation unit 20 (the brake operation unit 2 in the example of FIG. 1) operated by the driver. The control system 10 includes a sensor 11 and a control apparatus 12.

The sensor 11 detects an operation amount (that is, an operation amount of a brake operation) of the brake operation unit 2 operated by the driver of the vehicle 1 and outputs output information in accordance with the operation amount. In the example of FIG. 1, the sensor 11 is not built into the electric booster 3, but is disposed outside the electric booster 3. The position of the sensor 11 in the vehicle 1 when the sensor 11 is not built into the electric booster 3 is not particularly limited, and may be inside a passenger compartment or may be inside an engine compartment. However, the sensor 11 may be built into the electric booster 3.

The control apparatus 12 includes, for example, a central processing unit (CPU) which is an arithmetic processing unit, a read only memory (ROM) which is a memory element storing programs, arithmetic parameters and soon used by the CPU, and a random access memory (RAM) which is a memory element temporarily storing parameters and soon that change appropriately in the execution of the CPU.

Note that the function of the control apparatus 12 may be divided into a plurality of apparatuses, and a plurality of functions may be implemented by one apparatus. When the function of the control apparatus 12 is divided into a plurality of apparatuses, the plurality of apparatuses may be communicable with each other.

The control apparatus 12 mainly controls the electric booster 3. Specifically, the control apparatus 12 controls the operation of the electric motor of the electric booster 3 to control a force for assisting a brake operation force with the electric booster 3. Such a control is performed using the output information from the sensor 11.

Here, in addition to a process of controlling the operation of the electric booster 3 (corresponding to a first mode to be described below), the control apparatus 12 can perform a process of deactivating a sleep mode (corresponding to a second mode to be described below). In the sleep mode, the power consumption of the vehicle 1 is suppressed. For example, when the vehicle 1 is stationary and a state in which no driver's operation is performed continues for a predetermined time, the vehicle 1 enters the sleep mode. Both of the two processes described above are performed using the sensor 11. The details of the two processes described above will be described below.

### Operation of Control System

The operation of the control system 10 according to the embodiment of the invention will be described with reference to FIGS. 2 to 4.

As described above, the control apparatus 12 can perform the process of controlling the operation of the electric booster 3 and the process of deactivating the sleep mode. The control apparatus 12 executes the first mode as a processing mode for controlling the operation of the electric booster 3 and the second mode as a processing mode for deactivating the sleep mode. The control apparatus 12 can switches and executes the first mode and the second mode.

FIG. 2 is a flowchart illustrating an example of a processing flow performed by the control apparatus 12. Step S101 in FIG. 2 corresponds to the start of a control flow illustrated in FIG. 2.

After the control flow illustrated in FIG. 2 is started, in step S102, the control apparatus 12 determines whether the sleep mode is inactive.

When it is determined that the sleep mode is inactive (step S102/YES), the processing proceeds to step S103. In step S103, the control apparatus 12 switches the processing mode to the first mode, and the processing returns to step S102. On the other hand, when it is determined that the sleep mode is active (step S102/NO), the processing proceeds to step S104. In step S104, the control apparatus 12 switches the processing mode to the second mode, and the processing returns to step S102.

As described above, the first mode is executed while the sleep mode is inactive, and the second mode is executed while the sleep mode is active. Here, a correspondence relationship between an operation amount and output information in the sensor 11 differs between the first mode and the second mode. Accordingly, the control apparatus 12 can appropriately execute each of the first mode and the second mode.

FIG. 3 is a diagram illustrating a correspondence relationship between an operation amount X and output information Y in the sensor 11 in the first mode. In the first mode, the control apparatus 12 acquires the operation amount X of the brake operation unit 2 based on the output information Y of the sensor 11. Then, the control apparatus 12 controls the operation of the electric booster 3 based on the acquired operation amount X of the brake operation unit 2. A biasing force according to the operation amount X is applied to the brake operation unit 2 as a reaction force. Thus, the control apparatus 12 controls the electric booster 3 such that the greater the operation amount X is, the larger a force for assisting a brake operation force becomes.

As illustrated in FIG. 3, the output information Y in the first mode is information that indicates a value correlated with the operation amount X. Specifically, in the first mode, the output information Y increases as the operation amount X increases. For example, in the first mode, the output information Y indicates a value that is proportional to the operation amount X. In the first mode, the control apparatus 12 acquires the operation amount X based on such output information Y, and thus can control the force for assisting the brake operation force with the electric booster 3 in accordance with the operation amount X.

FIG. 4 is a diagram illustrating a correspondence relationship between an operation amount X and output information Y in the sensor 11 in the second mode. In the second mode, the control apparatus 12 deactivates the sleep mode based on the output information Y of the sensor 11. Specifically, the control apparatus 12 determines whether the brake operation unit 2 is pushed by the driver based on the output information Y of the sensor 11, and when it is determined that the brake operation unit 2 is pushed by the driver, deactivates the sleep mode.

As illustrated in FIG. 4, the output information Y in the second mode is information that indicates whether the operation amount X is larger than a reference operation amount X0. In the example of FIG. 4, the output information Y becomes 0 when the operation amount X is smaller than the reference operation amount X0, and the output information Y becomes 1 when the operation amount X is larger than the reference operation amount X0. The reference operation amount X0 is set to a value small enough to determine whether the brake operation unit 2 is pushed even slightly by the driver. In the second mode, when such output information Y is information indicating that the operation amount X is larger than the reference operation amount X0 (in the example of FIG. 4, when the output information Y is 1), the control apparatus 12 deactivates the sleep mode. Accordingly, the driver can easily deactivate the sleep mode by pushing the brake operation unit 2 while the sleep mode is active. After the sleep mode is deactivated, for example, when the vehicle 1 is stationary and a state in which no driver's operation is performed continues for a predetermined time, the vehicle 1 enters the sleep mode as described above.

As described above, in the control system 10, the correspondence relationship between the operation amount X and the output information Y in the sensor 11 is switched between the first mode and the second mode. For example, the control apparatus 12 switches a voltage applied to the sensor 11 between the first mode and the second mode. As a result, the sensor 11 can determine whether the processing mode of the control apparatus 12 is the first mode or the second mode by referencing the voltage applied to the sensor 11.

When it is determined that the processing mode of the control apparatus 12 is the first mode, the sensor 11 sets a correspondence relationship between the operation amount X and the output information Y such that the output information Y becomes information indicating a value correlated with the operation amount X. On the other hand, when it is determined that the processing mode of the control apparatus 12 is the second mode, the sensor 11 sets a correspondence relationship between the operation amount X and the output information Y such that the output information Y becomes information indicating whether the operation amount X is greater than the reference operation amount X0. Accordingly, the control apparatus 12 can appropriately execute each of the first mode and the second mode.

### Effects of Control System

The effects of the control system 10 according to the embodiment of the invention will be described.

The control system 10 includes the sensor 11 that detects the operation amount X of the operation unit 20 (in the example above, the brake operation unit 2) operated by the driver of the vehicle 1 and outputs the output information Y in accordance with the operation amount X, and the control apparatus 12 that can execute the sleep mode in which the power consumption of the vehicle 1 is suppressed. The control apparatus 12 can switch and execute the first mode which is executed while the sleep mode is inactive and acquires the operation amount X based on the output information Y, and the second mode which is executed while the sleep mode is active and deactivates the sleep mode based on the output information Y. The correspondence relationship between the operation amount X and the output information Y in the sensor 11 differs between the first mode and the second mode. Accordingly, the driver can easily deactivate the sleep mode by operating the operation unit 20 when the sleep mode is active, while the operation unit 20 is used for another purpose when the sleep mode is inactive. Therefore, the driver's comfort can be improved.

Preferably, in the control system 10, the output information Y in the first mode is information indicating a value correlated with the operation amount X, and the output information Y in the second mode is information indicating whether the operation amount X is larger than the reference operation amount X0. Accordingly, the control apparatus 12 can appropriately acquire the operation amount X in the first mode, and appropriately determine whether the operation unit 20 is operated by the driver in the second mode.

Preferably, in the control system 10, the control apparatus 12 deactivates the sleep mode when the output information Y in the second mode is information indicating that the operation amount X is larger than the reference operation amount X0. Accordingly, in the second mode, the sleep mode can be appropriately deactivated by using the fact that the operation unit 20 is operated by the driver as a trigger.

Preferably, in the control system 10, the operation unit 20 is the brake operation unit 2 used for the brake operation. Accordingly, the driver can easily deactivate the sleep mode by pushing the brake operation unit 2 while the sleep mode is active.

Preferably, the control system 10 includes the electric booster 3 that assists a brake operation force of the driver, and the control apparatus 12 controls the operation of the electric booster 3 based on the operation amount X of the brake operation unit 2 in the first mode.

Accordingly, in the first mode, a force for assisting the brake operation force by the electric booster 3 can be appropriately controlled in accordance with the operation amount X of the brake operation unit 2.

Preferably, in the control system 10, the sensor 11 is not built into the electric booster 3, but is disposed outside the electric booster 3. Accordingly, the driver's comfort can be improved in the vehicle 1 in which the sensor 11 is not built into the electric booster 3.

Although the preferred embodiment of the invention has been described above with reference to the accompanying drawings, it is obvious that the invention is not limited to the above-described embodiment, and it is also obvious that various changes and modifications within the scope described in the disclosure also belong to the technical scope of the invention.

In the foregoing, an example in which the operation unit 20 whose operation amount X is detected by the sensor 11 is the brake operation unit 2 has been described. However, the operation unit 20 whose operation amount X is detected by the sensor 11 may be any operation unit 20 other than the brake operation unit 2 (for example, an operation unit 20 operated by a driver's hand). In that case, the operation amount X acquired in the first mode may be used for any purpose other than the above-described purpose (that is, the purpose of controlling the operation of the electric booster 3). For example, the operation amount X acquired in the first mode may be used for controlling the operation of an apparatus other than the electric booster 3.

In the foregoing, an example in which the vehicle 1 includes the electric booster 3 has been described. However, the vehicle 1 need not include the electric booster 3. In that case, for example, the operation amount X acquired in the first mode may be used for controlling the operation of the hydraulic pressure control unit 4. Further, the vehicle 1 may be an engine vehicle including only an engine as a drive source, may be an electric vehicle including only a motor as a drive source, or may be a hybrid vehicle including an engine and a motor as drive sources.

### REFERENCE SIGNS LIST

1: Vehicle
2: Brake operation unit
3: Electric booster
4: Hydraulic pressure control unit
10: Control system
11: Sensor
12: Control apparatus
20: Operation unit
X: Operation amount
X0: Reference operation amount
Y: Output information

1. A control system (10) for controlling operation of a vehicle (1), the control system (10) comprising:
a sensor (11) configured to detect an operation amount (X) of an operation unit (20) operated by a driver of the vehicle (1) and to output output information (Y) in accordance with the operation amount (X); and
a control apparatus (12) configured to execute a sleep mode in which power consumption of the vehicle (1) is suppressed,
the control apparatus (12) further configured to execute a first mode when the sleep mode is inactive and acquire the operation amount (X) based on the output information (Y), and execute a second mode when the sleep mode is active and deactivate the sleep mode based on the output information (Y),
wherein a correspondence relationship between the operation amount (X) and the output information (Y) in the sensor (11) is different between the first mode and the second mode.

2. The control system according to claim 1, wherein
the output information (Y) in the first mode comprises information indicating a value correlated with the operation amount (X), and
the output information (Y) in the second mode comprises information indicating whether the operation amount (X) is larger than a reference operation amount (X0).

3. The control system according to claim 2, wherein, in the second mode, the control apparatus (12) deactivates the sleep mode when the output information (Y) comprises information indicating that the operation amount (X) is larger than the reference operation amount (X0).

4. The control system according to claim 1, wherein the operation unit (20) is a brake operation unit (2) used for a brake operation.

5. The control system according to claim 4, further comprising an electric booster (3) configured to assist a brake operation force of the driver, wherein, in the first mode, the control apparatus (12) controls operation of the electric booster (3) based on the operation amount (X) of the brake operation unit (2).

6. The control system according to claim 5, wherein the sensor (11) is not built into the electric booster (3), but is disposed outside the electric booster (3).
